(19) United States
(12) Patent Application Publication
(10) Pub. No.: US 2010/0118663 A1
(43) Pub. Date: May 13, 2010

(54) METHOD AND APPARATUS FOR PROCESSING REQUEST FROM APPLICATION IN HOME NETWORK

(75) Inventors: Kwang-hyuk KIM, Suwon-si (KR); Gyung-pyo HONG, Yongin-si (KR); Young-soo KANG, Seoul (KR); Jung-shin PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/613,858

(22) Filed: Nov. 6, 2009

Related U.S. Application Data
(60) Provisional application No. 61/112,277, filed on Nov. 7, 2008.

(30) Foreign Application Priority Data
Dec. 24, 2008 (KR) 10-2008-0133842

(51) Int. Cl. H04H 60/27

(52) U.S. Cl. 369/7

(57) ABSTRACT

A method is used by an Open Cable-Digital Media Player (OC-DMP) to process a request of an application with respect to content of an Open Cable-Digital Media Server (OC-DMS). The method includes determining validity of the request based on metadata of the content, and selectively transmitting the request to the OC-DMS based on a result of the determination.

### CROSS-REFERENCE TO RELATED PATENT APPLICATIONS

This application claims the benefit of U.S. Provisional Application No. 61/122,277, filed Nov. 7, 2008, and the priority from Korean Patent Application No. 10-2008-0133842, filed Dec. 24, 2008, in the Korean Intellectual Property Office. The disclosures of each of these applications is incorporated hereby by reference in its entirety.

### BACKGROUND

1. Field

Apparatuses and methods consistent with the inventive concept relates to a home network, and more particularly, to processing a request of an application of an Open Cable-Digital Media Player (OC-DMP) with respect to the content of an OC-Digital Media Server (OC-DMS).

2. Description of the Related Art

A data broadcast service provides broadcast programs, as well as general information regarding broadcast programs, neighborhood news, internet connection, electronic merchandising, etc., via a broadcast network, such as a ground wave network, a satellite network, or a cable network. Examples of currently used standards of a data broadcast service include Open Cable Application Platform (OCAP), Advanced Common Application Platform (ACAP), and Multimedia Home Platform (MHP).

OCAP home networking protocol standards define an OC-DMP for broadcast content playback and an OC-DMS for broadcast content management. An OC-DMP provides a RecordingNetModule, which is a service module enabling an application to perform tasks related to a home network.

When an application requests to record particular broadcast content, the RecordingNetModule transmits the request to an OC-DMS by using a protocol according to Digital Living Network Alliance (DLNA) standards. A NetRecordingRequestManager of the OC-DMS, which receives the request, records the particular broadcast content according to the request.

Other than such a recording request, an application may perform various tasks, such as canceling recording or setting up recording priorities, via the RecordingNetModule. An application may also perform tasks other than those related to recording with respect to content of the OC-DMS according to various requests, such as a request to copy, delete, or move content, a request to browse content of the OC-DMS, etc., via a ContentServerNetModule.

Here, such requests may be embodied via application programming interfaces (API) of modules generated by an OC-DMP corresponding to services of an OC-DMS. An application may use services provided by an OC-DMS by loading methods of application programming interface (API) and the methods are respectively mapped to universal plug and play (UPnP) actions. For example, an OC-DMP generates RecordingNetModule when a service description regarding a UPnP scheduled recording service (SRS) is received, and calls DeleteResource action defined in the UPnP SRS provided by the OC-DMS when an application calls a requestDelete operation of the RecordingNetModule to cancel a recording operation.

In such an environment, it is difficult to provide proper protection to content of an OC-DMS when the various applications of an OC-DMP perform recording, copying, and deleting with respect to the content of the OC-DMS. According to the current OCAP standards, an OC-DMP determines whether an application, which requested recording, has permission with respect to the corresponding content. If it is determined that the application does not have permission, the OC-DMP informs the application that an exception regarding security occurred, instead of requesting recording of the content to an OC-DMS.

However, in the case of an invalid request, e.g., designating normal content instead of the recorded content when requesting to cancel recording, an OC-DMS determines that the request is invalid and informs an OC-DMP about the error. In other words, an OC-DMP in the related art determines whether an application that requested recording has proper permission for the recording request, and, in other cases, an OC-DMS determines whether a request is valid and sends feedback to the OC-DMP. In the case where a request of the OC-DMP is invalid, problems, such as time delay and increased traffic, may occur.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

According to one or more exemplary embodiments, there is provided a method an apparatus for an OC-DMP to efficiently process a request of an application in a home network.

According to an aspect of an exemplary embodiment, there is provided a method for an OC-DMP to process a request of an application with respect to content in an OC-DMS, the method including determining whether the request is valid or invalid based on metadata of the content; and selectively transmitting the request to the OC-DMS based on a result of the determination.

It may be determined whether the application has permission to control the content according to the request or not during the determination of whether the request is valid or invalid.

The metadata may include at least one of an identifier of an application having permission to control the content according to the request, an identifier of the author of the application having permission to control the content according to the request, and an identifier of a provider of the application having permission to control the content according to the request.

The request may be a request transmitted to the OC-DMS via a RecordingNetModule of the OC-DMP, and the determination of whether the request is valid or invalid may include determining whether the content is recorded content or not.

The content may be determined as recorded content when a parameter indicating the target of the request is RecordedContentItem or NetRecordingEntry.

The request may include at least one selected from the group consisting of a read instruction, a delete instruction, and a record instruction.

According to another aspect of an exemplary embodiment, there is provided a computer-readable recording medium having recorded thereon a computer program for executing the method.

According to another aspect of an exemplary embodiment, there is provided an apparatus with which an OC-DMP processes a request of an application with respect to content in an OC-DMS, the apparatus including a determining unit which determines whether the request is valid or invalid based on metadata of the content; and a transmitting unit which selectively transmits the request to the OC-DMS based on a result of the determination.

The determining unit may include a permission determining unit, which determines whether the application has permission to control the content according to the request or not.

The request may be a request transmitted to the OC-DMS via a RecordingNetModule of the OC-DMP, and the determining unit may include a content type determining unit which determines whether the content is recorded content or not.

The content type determining unit may determine that the content is recorded content when a parameter indicating the target of the request is RecordedContentItem or NetRecordingEntry.

### BRIEF DESCRIPTION OF THE DRAWINGS

The above and other aspects will be more apparent by describing certain exemplary embodiments with reference to the accompanying drawings, in which:

FIG. 1 is a diagram illustrating processing a request from an application by an OC-DMP in a home network according to an exemplary embodiment;

FIG. 2 is a flowchart illustrating processing of a request of an application in an OC-DMP, according to an exemplary embodiment;

FIG. 3 is a flowchart illustrating determining whether a request of an application is valid according to an exemplary embodiment; and

FIG. 4 is a diagram showing the structure of an OC-DMP apparatus according to an exemplary embodiment.

### DETAILED DESCRIPTION OF EXEMPLARY EMBODIMENTS

Certain exemplary embodiments are described in greater detail with reference to the accompanying drawings.

In the following description, like drawing reference numerals are used for like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

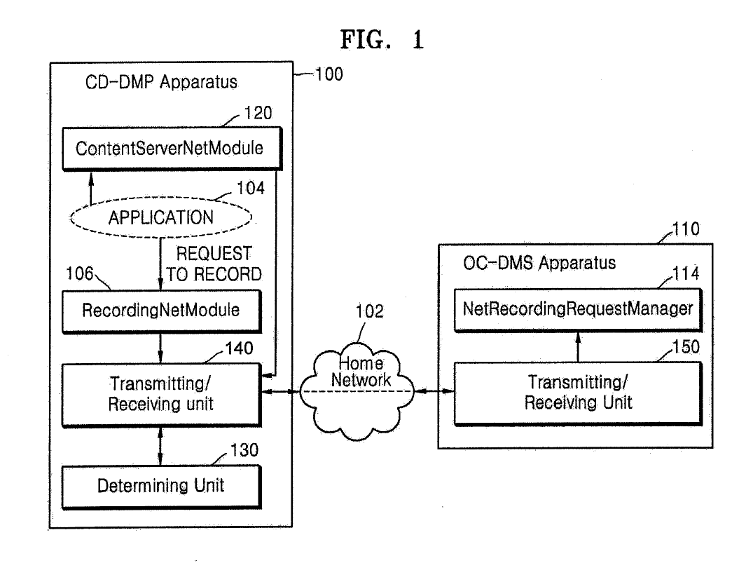

FIG. 1 illustrates a method used by an OC-DMP apparatus 100 to process a request from an application, in a home network 102. As shown in FIG. 1, when an application 104 requests to record particular broadcast content, the RecordingNetModule 106 transmits the request to an OC-DMS apparatus 110 by using a protocol according to DLNA standards. A NetRecordingRequestManager 114 of the OC-DMS, which receives the request, records the particular broadcast content according to the request.

An application 104 may also perform canceling recording or setting up recording priorities via the RecordingNetModule 106. The application 104 may also perform other tasks with respect to the content of the OC-DMS according to various requests, such as a request to copy, delete, or move content, a request to browse content of the OC-DMS, etc., via a ContentServerNetModule 120.

The requests may be embodied via application programming interfaces (API) of modules generated by the OC-DMP 100 corresponding to services of the OC-DMS 110. The application 104 may use services provided by the OC-DMS 110 by loading functionalities of UPnP. For example, an OC-DMP 100 generates RecordingNetModule 106 when a service description regarding a UPnP SRS is received, and calls DeleteResource action defined in the UPnP SRS provided by the OC-DMS 110 when an application 104 calls a requestDelete method of the RecordingNetModule 106 to cancel a recording operation.

As described in a greater detail below, the OC-DMP 100 includes a determining unit 130, which determines whether a request from an application is valid, and a transmitting/receiving unit 140, which selectively transmits the request from the application to a transmitting/receiving unit 150 of an OC-DMS apparatus 110 based on the determination of the determining unit 130. The request may be a read instruction, a delete instruction, and/or a record instruction.

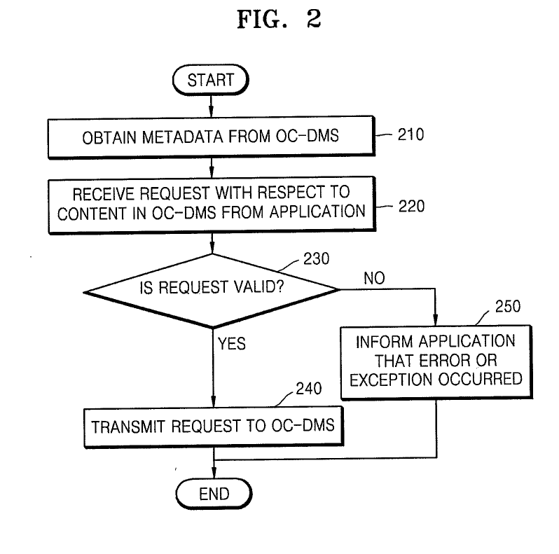

FIG. 2 is a flowchart illustrating processing of a request of an application in an OC-DMP, according to an exemplary embodiment.

In operation 210, an OC-DMP obtains metadata regarding content from an OC-DMS. The operation may be performed by using functionalities of a ContentServerNetModule, such as a requestRootContainer functionality and a requestBrowserEntries functionality. In other words, when an application calls such functionalities, the UPnP control messages for calling UPnP actions respectively corresponding to the functionalities are transmitted to the OC-DMS. The functionalities are defined in the OCAP home networking protocol standards, and thus detailed descriptions thereof are omitted.

In operation 220, the OC-DMP receives a request regarding content in the OC-DMS, from an application. Here, the request refers to a command for instructing the performance of various tasks, such as recording, recording cancellation, copying, deleting, and moving, with respect to the content.

In operation 230, the OC-DMP determines whether the request is valid, based on the metadata of the content. For example, the OC-DMP determines whether the request is valid by determining whether a parameter required for the request is missing, whether the application has permission to control the content according to the request, and/or whether the content is appropriate for the requested task.

Here, the metadata refers to various additional pieces of information regarding the content, such as an identifier of an application having permission to control content according to the corresponding request, an identifier of the author of an application having permission to control content according to the corresponding request, and/or an identifier of a provider of an application having permission to control content according to the corresponding request. Permission to control content may be issued to the applications according to the types of tasks. For example, an application may have permission to read particular content, but the application may not have permission to delete the particular content.

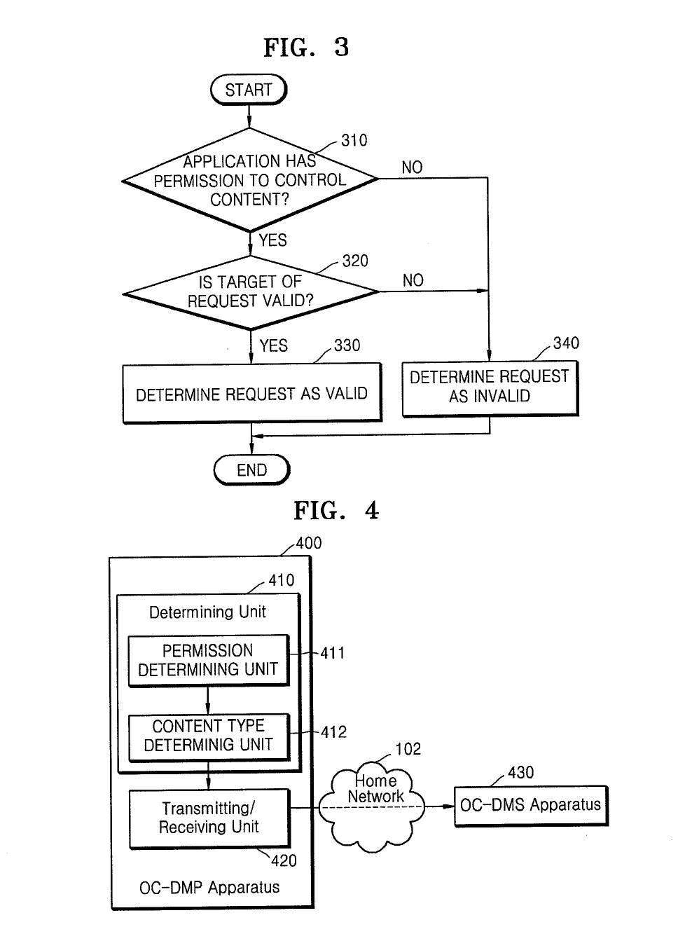

Detailed descriptions regarding determination of validity of a request will be described later in reference to FIG. 3.

If the request is valid, the request is transmitted to the OC-DMS, in operation 240. In other words, a UPnP control message to call an UPnP action corresponding to the request is transmitted to the OC-DMS. For example, in the case where an application calls a requestCopy functionality to copy the content, a control message to call a DeleteResource action of an UPnP CDS is transmitted to the OC-DMS.

If the request is invalid, the application is informed that an error or an exception occurred, in operation 250.

As described above, according to the exemplary embodiment, an OC-DMP determines validity of a request of an application before the request is transmitted to the OC-DMS, and the request is not transmitted if the request is determined to be invalid. Thus, the time required to process a request may be shortened. Furthermore, feedback received from the OC-DMS in the case where an invalid request is transmitted may be prevented, and thus traffic in a home network may be reduced.

FIG. 3 is a flowchart illustrating the determining whether a request of an application is valid, according to an exemplary embodiment.

In operation 310, an OC-DMP determines whether an application has permission to control content regarding a corresponding request, based on the metadata. Since various applications may be installed in the OC-DMP, permission to control content regarding content may be limited to particular applications for protection of the content. Permission to control content regarding a task may be given to an application according to the policy of a content provider.

For example, with respect to the particular content, permission to control content regarding a particular task may be issued to an application that generated the content (that is, an application which has controlled the content to be stored in the OC-DMS), an application of a particular author, or an application of a particular provider. As described above, the metadata of content includes identifiers of applications having permission to control content with respect to various tasks, identifiers of authors of the applications, and/or identifiers of providers of the applications. Thus, the OC-DMP may determine whether an application has permission according to the corresponding request, by referring to the metadata of content.

Although permission to control content may be distinctively issued with respect to each task, permission to control content may also be issued to an application, to which permission to control content with respect to one representative task is issued, with respect to various tasks relevant to the representative task. For example, if an application has WRITE permission, an OC-DMP may consider that the application also has permissions for other tasks, such as recording cancellation, schedule management, and/or content deletion.

If the application does not have permission according to the corresponding request, the request is determined as invalid in operation 340. Thus, the request is not transmitted to the OC-DMS.

If it is determined that the application has the permission to control content, the OC-DMP determines whether a target of the request is valid, in operation 320. For example, in the case of a request for recording cancellation, the request is determined as invalid if the target of the request is normal content rather than recorded content. The OC-DMP determines that the target of the request is recorded content if a parameter indicating the target of the request includes RecordedContentItem or NetRecordingEntry. Thus, the OC-DMP determines that the target of the request is invalid when a parameter indicating the target of the request is not RecordedContentItem or NetRecordingEntry, i.e., a particular parameter is missing. The RecordedContentItem is a parameter indicating one independent recorded content, and the NetRecordingEntry is a parameter indicating one group including a plurality of pieces of recorded content.

This method of processing may be applied not only to a request to record cancellation, but also may be applied to any recording-related requests processed via RecordingNetModule. Examples of such recording-related requests include a request to delete metadata related to a recording operation, a request to delete object information, a request to set priorities between recording contents, and a request to modify settings of a scheduled recording operation.

If the target of the request is invalid, the corresponding request is determined as invalid in the operation 340. Thus, such a request is not transmitted to the OC-DMS.

In the current exemplary embodiment, it is first determined whether an application has permission to control content, and then it is determined whether a target of a request is valid. However, according to embodiments, these determinations may be performed in a different order. Furthermore, one of the determinations may be omitted, and each of these determinations may be performed independently.

FIG. 4 is a diagram showing the structure of an OC-DMP apparatus 400 according to an exemplary embodiment.

The OC-DMP apparatus 400 includes a determining unit 410, which determines whether a request from an application is valid and a transmitting/receiving unit 420, which selectively transmits the request from the application to an OC-DMS apparatus 430 based on the determination of the determining unit 410. Here, the request refers to a read instruction, a delete instruction, and/or a record instruction.

The determining unit 410 may determine whether a request from an application is valid based on whether the application has permission to control content according to the request. Thus, the determining unit 410 may include a permission determining unit 411 which determines whether an application has permission to control content according to a corresponding request based on the metadata of the content.

Furthermore, when a request from an application is a recording-related request that is transmitted to the OC-DMS 430 via RecordingNetModule 106, if the type of content, which is the target of the request, is not the recorded content, the target of the request is invalid. Thus, the determining unit 410 may determine that the request is invalid. Therefore, the determining unit 410 may include a content type determining unit 412 which determines whether the target of a request is valid based on whether the target of the request is the recorded content.

In the case where a request is invalid, the determining unit 410 informs a corresponding application that an error or an exception occurred.

In the case where a parameter indicating the target of a request is either RecordedContentItem or NetRecordingEntry, the content type determining unit 412 determines that the target of the request is the recorded content. In other words, in the case where a parameter indicating the target of the request is either RecordedContentItem or NetRecordingEntry, it is determined that the target of the request is valid.

As described above, the determination of whether an application has permission to control content and the determination of whether a target of a request is valid may be performed independently, and thus, one of the permission determining unit 411 and the content type determining unit 412 may be omitted according to exemplary embodiments.

Exemplary embodiments may be implemented as computer programs and implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), and other types of storage media.

The foregoing embodiments and advantages are merely exemplary and are not to be construed as limiting the inventive concepts. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for processing in an Open Cable-Digital Media player (OC-DMP) a request of an application with respect to content of an Open Cable-Digital Media Server (OC-DMS), the method comprising:
determining whether the request is valid based on metadata of the content; and
selectively transmitting the request to the OC-DMS based on a result of the determining.

2. The method of claim 1, wherein the determining whether the request is valid comprises:
determining whether the application has permission to control the content according to the request.

3. The method of claim 2, wherein the metadata comprises at least one of an identifier of an application having permission to control the content according to the request, an identifier of an author of the application having permission to control the content according to the request, and an identifier of a provider of the application having permission to control the content according to the request.

4. The method of claim 1, wherein the request is transmitted to the OC-DMS via a RecordingNetModule of the OC-DMP, and
the determining whether the request is valid comprises determining whether the content is recorded content.

5. The method of claim 4, wherein it is determined that the content is recorded content if a parameter indicating a target of the request is RecordedContentItem or NetRecordingEntry.

6. The method of claim 1, wherein the request comprises at least one selected from the group consisting of a read instruction, a delete instruction, and a record instruction.

7. The method of claim 1, further comprising, if it is determined that the request is not valid, informing the application that an error or an exception has occurred.

8. An apparatus with which an Open Cable-Digital Media Player (OC-DMP) processes a request of an application with respect to content of an Open Cable-Digital Media Server (OC-DMS), the apparatus comprising:
a determining unit which determines whether the request is valid based on metadata of the content; and
a transmitting/receiving unit which selectively transmits the request to the OC-DMS based on a result of a determination by the determining unit.

9. The apparatus of claim 8, wherein the determining unit comprises a permission determining unit, which determines whether the application has permission to control the content according to the request.

10. The apparatus of claim 9, wherein the metadata comprises at least one of an identifier of an application having permission to control the content according to the request, an identifier of an author of the application having permission to control the content according to the request, and an identifier of a provider of the application having permission to control the content according to the request.

11. The apparatus of claim 8, wherein the request is transmitted to the OC-DMS via a RecordingNetModule of the OC-DMP, and
the determining unit comprises a content type determining unit which determines whether the content is recorded content.

12. The apparatus of claim 11, wherein the content type determining unit determines that the content is recorded content if a parameter indicating a target of the request is RecordedContentItem or NetRecordingEntry.

13. The apparatus of claim 8, wherein the request comprises at least one selected from the group consisting of a read instruction, a delete instruction, and a record instruction.

14. The apparatus of claim 8, wherein, if the determining unit determines that the request is not valid, the determining unit informs the application that an error or an exception has occurred.

15. A computer-readable recording medium having recorded thereon a computer program which, when executed by a computer, causes the computer to perform the method of claim 1.
